(19) United States
(12) Patent Application Publication
(10) Pub. No.: US 2008/0179790 A1
(43) Pub. Date: Jul. 31, 2008

(54) Method to Form a High Strength Moulded Product

(75) Inventors: Teck Tin Wong, Singapore (SG); Tee Jong Hui, Singapore (SG); Shin Huay Ong, Singapore (SG)

Correspondence Address: BIRCH STEWART KOLASCH & BIRCH, PO BOX 747, FALLS CHURCH, VA, 22040-0747, US

(73) Assignee: GPAC TECHNOLOGY (S) PTE LTD, Singapore (SG)

(21) Appl. No.: 11/628,839

(22) PCT Filed: Apr. 1, 2005
(86) PCT No.: PCT/SG05/00109

§ 371 Date: Dec. 8, 2006

(30) Foreign Application Priority Data
Jun. 11, 2004 (SG) 200403634-9

(51) Int. Cl. B29C 43/58

(52) U.S. Cl. 264/325; 252/363.5; 366/91

(57) ABSTRACT

A method to form a high strength moulded product is provided. The method begins by preparing a mouldable composition. The mouldable composition comprises between about 40 to 60 wt % of a fibre mixture and between about 15 to 45 wt % of an adhesive. A mould cavity is loaded with the mouldable composition up to about 90 % of the capacity of the mould cavity before applying a packing pressure of between about 435 to 870 psi to the mouldable composition. A predetermined clearance of between about 0.1 to 0.5 mm is maintained between a first mould part defining the mould cavity and a second mould part. The moulded product is removed from the mould cavity when the mouldable composition is substantially cured.

### BACKGROUND OF THE INVENTION

1. Field of the Invention

The present invention relates generally to a high strength moulded product such as, for example, a pallet or a piece of furniture. More particularly, the present invention relates to a method to form a high strength moulded product from a mouldable composition.

2. Description of the Related Art

Conventionally, most products are manufactured from natural resources such as oil, minerals, wood or metal. However, with increasing environmental awareness, the trend is towards reusing and recycling products to conserve natural resources and to minimise waste generated.

An environmentally friendly alternative to reusing and recycling products that is attracting much research interest is the use of agricultural and horticultural waste as a raw material. The objective of such research is to find a substitute for conventional raw materials such as wood, metal, plastic, wood-chips, particle-boards, et cetera, to realise the goals of waste minimisation and natural resource conservation. Accordingly, a number of methods for manufacturing moulded products using wood waste, agricultural and horticultural waste and mouldable compositions for use in such methods have been disclosed.

European Patent Publication No. 1176174 filed by CS Environmental Technology Limited Hong Kong (HK) discloses a degradable material for the production of, amongst other things, construction materials, handrails for staircases, door planks, floor boards and furniture materials. The degradable material comprises horticultural and agricultural waste as a base ingredient, and an adhesive agent. The base ingredient is prepared by grinding plant fibres in a crushing machine until the plant fibres are sufficiently fine to pass through a sieve of at least 20 meshes, that is, a sieve having apertures of about 0.80 millimetres (mm) in size or smaller.

The degradable material is prepared by adding the adhesive agent, at a temperature of 20 to 60° C., to the base ingredient and mixing the resultant mixture at a speed of 200 to 600 revolutions per minute (rpm) for 20 to 40 minutes (min). The temperature of the resultant mixture is then raised to 80 to 100° C. for another 5 to 20 min for further mixing. The degradable material is formed when the resultant mixture is subsequently cooled to room temperature.

Because the plant fibres making up the base ingredient are so fine, a large quantity of adhesive agent is required to give the moulded product its requisite strength. The use of a large quantity of adhesive agent increases manufacturing cost. It is also more costly to use finer fibres as compared to coarser fibres.

Further, the additional step of heating the degradable material to 80 to 100° C. for further mixing increases manufacturing cost and lengthens the processing time for each production cycle.

Similarly, International Patent Publication No. WO 02/20667 filed by Choo Thiam Huay, Gary, discloses the use of plant fibres for the manufacture of a moulded product such as a tabletop, a partition or a golf tee. The moulded product is formed from a moulding mixture comprising 40 to 60 percentage by weight (wt %) of a plant fibre with up to 10 wt % of starch, 10 to 55 wt % of water and 3 to 10 wt % of a water-soluble adhesive. The moulding mixture is poured into a mould and subjected to a temperature between 15 to 60° C. and a pressure in a range of 1000 to 7000 pounds per square inch (psi) for a period of time before reducing the pressure to prevent an explosion. Temperature and pressure are subsequently increased to between 100 to 200° C. and between 500 to 1500 psi, respectively, prior to removing the moulded product from the mould.

Because a significant amount of water is added to form the moulding mixture, the moisture content of the moulding mixture is rather high. Consequently, a large quantity of moisture vaporises during the moulding process, increasing the pressure in the moulding mixture during processing, which in turn increases the risk of the moulded product delaminating when the mould is opened because of the sudden release of pressure.

Additionally, a high moisture content may dilute the adhesive to an extent where the adhesive is no longer effective as a binder to bind the plant fibres. No moulded product can be formed under such circumstances.

Another disadvantage of the moulded product disclosed in International Patent Application No. PCT/SG01/00180 is that it is not water-resistant and therefore disintegrates when in contact with liquid. Hence, additional processing steps of coating the moulded product with a water-resistant material and letting the water-resistant coating dry are required. These additional steps add to the cost of producing the moulded product and lengthen the time required for each production cycle.

Further, it is not practical to vary the processing temperature during the moulding process as it takes a while for the mould and the mouldable mixture to attain a desired temperature; varying the processing temperature would lengthen the processing time for each production cycle significantly.

Other methods and mouldable compositions are directed towards the manufacture of moulded products such as tableware, containers and packaging material, which do not require significant strength and are therefore not able to withstand significant stresses prior to failure.

In view of the foregoing, it is desirable to have a method to form a high strength moulded product from wood waste, agricultural and/or horticultural waste that is inherently water-resistant and therefore does not require a further coating of water-resistant material. It is also desirable to have a method to form a high strength moulded product that does not require substantial variations in processing temperature. Additionally, it is desirable to have a method to form a high strength moulded product economically and in a short production cycle time.

### SUMMARY OF THE INVENTION

The present invention fills these needs by providing a method to form a high strength moulded product from a mouldable composition. It should be appreciated that the present invention can be implemented in numerous ways, including as a process, an apparatus, a system, a device or a method. Several inventive embodiments of the present invention are described below.

One embodiment of the present invention provides a method to form a high strength moulded product. The method begins by preparing a mouldable composition. The mouldable composition comprises between about 40 to 60 wt % of a fibre mixture and between about 15 to 45 wt % of an adhesive. A mould cavity is loaded with the mouldable composition up to about 90% of the capacity of the mould cavity before applying a packing pressure of between about 435 to 870 psi to the mouldable composition. A predetermined clearance of between about 0.1 to 0.5 mm is maintained between a first mould part defining the mould cavity and a second mould part. The moulded product is removed from the mould cavity when the mouldable composition is substantially cured. The pressure is preferably applied for a period of between about 20 to 60 s.

Preferably, the first mould part and the second mould part are maintained at a temperature of between about 110 to 180° C. More preferably, the first mould part is maintained at a temperature of about 20° C. higher than a temperature of second mould part.

The clearance between the first mould part and the second mould part is preferably increased to about 10 mm when the mouldable composition is about 90% cured.

The moulded product is preferably compressed to a desired thickness and a surface of the moulded product is preferably ironed by reducing the clearance between the first mould part and the second mould part to between about 0.05 to 0.3 mm for between about 15 to 60 s.

Preferably, the mouldable composition includes not more than about 40 wt % of an additive. The additive may be one of a group consisting of a hardener, a flow promoter and a mould release agent.

Preferably, a moisture content of the mouldable composition is less than about 20%. More preferably, a moisture content of the mouldable composition is between about 4 to 15%. A moisture content of the fibre mixture is preferably less than about 15%.

The fibre mixture preferably comprises a plurality of fibres, each of the plurality of fibres having a length of up to about 50 mm and a thickness of up to about 2 mm. Preferably, each of the plurality of fibres is of a length to a thickness ratio of between about 2:1 to 25:1. The fibre mixture preferably includes between about 5 to 30 wt % of a palm oil fibre. Preferably, the fibre mixture includes one of a group consisting of oil palm fibres, beer malt, sugarcane pulp, a plasticizer, a toughening agent and an impact modifier.

The adhesive is preferably a thermosetting resin. More preferably, the adhesive is an amino resin.

Preferably, the adhesive includes melamine. The adhesive may be one of a group consisting of melamine formaldehyde and melamine urea formaldehyde.

The mouldable composition is preferably prepared by weighing each component of the mouldable composition individually before combining each component of the mouldable composition in a mixer to form a substantially homogeneous and well-coated mouldable composition. Preferably, each liquid component of the mouldable composition is combined in a second mixer to form a liquid mixture, which is preferably sprayed into the mixer. The mixer is preferably operated at a rotor speed of about 29 rpm.

In another embodiment of the invention, a method to form a moulded product is provided. The method begins by loading a cavity of a mould with a mouldable composition comprising between about 40 to 60 wt % of a fibre mixture and between about 15 to 45 wt % of an adhesive. The cavity is loaded up to about 90% of the capacity of the cavity. Thereafter, the mould is activated so as to apply a packing pressure in the range 435 to 870 psi to the mouldable composition therein. A moisture vapour vent is provided. The moisture vapour vent is responsive to pressure in the mouldable composition and set to provide a predetermined control of moisture vapour content and thereby pressure in the composition, whereby to produce a moulded product having predetermined density and strength. The moulded product is removed from the mould cavity when the mouldable composition is substantially cured.

Preferably, the vent is provided by maintaining a clearance between respective parts of the mould adjacent the mouldable composition. The vent may be temporarily occluded by the mouldable composition in the mould to temporarily prevent release of moisture vapour for a predetermined period.

The moisture vapour content is preferably controlled to generate bubbles of the vapour in the mouldable composition and thereby produce a porous moulded product of predetermined density.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a flow chart illustrating a method to prepare a mouldable composition in accordance with one embodiment of the present invention.

FIG. 2 is a flow chart illustrating a method to prepare a fibre mixture in accordance with one embodiment of the present invention.

FIG. 3 illustrates a press to form a moulded product in accordance with one embodiment of the present invention.

FIG. 4 illustrates an enlarged view of a mould cavity and a mould plunger during the formation of a moulded product in accordance with one embodiment of the present invention.

FIG. 5A illustrates a cross-sectional view of an ejection mechanism at rest in accordance with embodiment of the present invention.

FIG. 5B illustrates a cross-sectional view of an ejection mechanism in operation in accordance with embodiment of the present invention.

FIG. 6 is a flow chart illustrating a method to form a moulded product in accordance with one embodiment of the present invention.

### DETAILED DESCRIPTION OF THE PREFERRED EMBODIMENTS

A method to form a high strength moulded product from a mouldable composition is provided. In the following description, numerous specific details are set forth in order to provide a thorough understanding of the present invention. It will be understood, however, to one skilled in the art, that the present invention may be practised without some or all of these specific details. In other instances, well known process operations have not been described in detail in order not to unnecessarily obscure the present invention.

The mouldable composition comprises between about 40 to 60 percentage by weight (wt %) of a fibre mixture and between about 15 to 45 wt % of an adhesive. The mouldable composition may include not more than about 40 wt % of an additive.

The moisture content of the mouldable composition is preferably less than about 20%, more preferably between about 4 to 15%. A higher moisture content dilutes the concentration of the adhesive in the mouldable composition. Hence, a longer processing time is required to cure a mouldable composition with higher moisture content.

Further, in keeping the moisture content of the mouldable composition to less than about 20%, the need for a further post curing process to remove moisture from the moulded product to prevent fungus growth is done away with. By minimising the number of processing steps, the moulded product may be produced at a lower cost and in a shorter production cycle time.

As moisture is inherent in the fibre mixture and possibly in the adhesive and additive as well, addition of water is not required. The moisture content of the fibre mixture is preferably less than about 15%. Rather, the moisture content of the mouldable composition may be reduced by adding between about 10 to 20 wt % of a co-solvent with a lower boiling point than water, such as, for example, alcohol.

The fibre mixture may comprise wood waste from building construction, used furniture, used wooden pallets and sawdust, and/or agricultural and horticultural waste such as, for example, leaves, stems and branches. Fibres from wood waste and agricultural and horticultural waste are readily available at a low cost and give good acoustic and thermal insulation properties to the moulded product. In addition, such fibres also confer stiffness to the moulded product, making it resistant to deformation when subjected to stresses.

Fibres with a length of up to about 50 millimetre (mm), a thickness of up to about 2 mm and a length to thickness ratio of between about 2:1 to 25:1 are preferred. Because the moulded product derives its strength from the fibre, and not the bonding provided by the adhesive, the use of a longer fibre is preferred even though longer fibres provide less surface area for bonding. Accordingly, a smaller quantity of adhesive is required when longer fibres are used in the mouldable composition.

Between about 5 to 30 wt % of an oil palm fibre may be included in the fibre mixture to increase the elasticity and ductility of the moulded product, making the moulded product less brittle. However, a higher content of oil palm fibre may reduce the strength of the moulded product as oil palm fibres are generally smaller in size, typically having a length of up to about 50 mm and a thickness of between about 0.3 to 1 mm. Accordingly, the composition of oil palm fibre in the fibre mixture may be varied according to the desired properties of the moulded product.

The addition of oil palm fibre is also preferred because oil palm fibre has low moisture content and contains lignin, which is a good dispersing agent and serves as a binder when subjected to pressure.

The oil palm fibre may be obtained from various parts of an oil palm such as, for example, the trunk, fronds and fruit. These parts of the oil palm are usually junked. Hence, the present invention provides a way to reduce wastage and to minimise environmental pollution caused by the incineration of the oil palm.

Apart from being low in cost, oil palm fibres are readily available throughout the year in various sizes.

Although less preferred, alternatives, such as, for example, beer malt and sugarcane pulp or a chemical such as a plasticizer, a toughening agent or an impact modifier, may be employed in place of oil palm fibres to improve the ductility and elasticity of the moulded product.

The adhesive is preferably a thermosetting resin such as, for example, an amino resin, an epoxy resin, an allylic resin, a phenolic resin, a polyimide, silicone, a polyester, a polyaromatic or a furan. More preferably, the adhesive is an amino resin because such resins blend well with the fibre mixture to form a homogeneous mixture and result in the formation of a moulded product that is resistant to heat, stress and chemicals. Amino resins are thermosetting plastic materials that are produced by reacting a compound bearing an amino group (—NH₂) such as aniline, ethylene urea, guanamines, melamines, sulphonamide, thiourea and urea with a formaldehyde.

Preferably, the adhesive contains melamine, which confers durability, as well as heat and water resistance, to the moulded product. Examples of melamine containing adhesives include melamine formaldehyde and melamine urea formaldehyde. A moulded product formed with melamine urea formaldehyde will have an almost negligible amount of formaldehyde because during the moulding process, almost all the formaldehyde in the amino resin vaporises, leaving a negligible quantity of formaldehyde in the moulded product. Accordingly, the free formaldehyde emission from such a moulded product is minimal and will therefore not pose a health threat.

The additive may include between about 0.1 to 0.4 wt % of a hardener such as ammonium chloride to accelerate the curing process of the adhesive, between about 6 to 18 wt % of a flow promoter such as tapioca flour to enhance the flow of the mouldable composition and between about 0.2 to 0.9 wt % of a mould release agent, preferably, soy lecithin, to assist in the removal of the moulded product from a mould.

Soy lecithin is a preferred mould release agent because it is plant-based, renewable, biodegradable, does not contain any toxic additive and will not release any toxic vapours during moulding.

Tables 1A, 1B and 1C illustrate examples of mouldable compositions that may be used to form a pallet in accordance with one embodiment of the present invention.

TABLE 1A
(all amounts in wt %)

| | Example 1 | Example 2 | Example 3 | Example 4 |
|---|---|---|---|---|
| Plant Fibre | 53.2 | 44.1 | 46.2 | 49.9 |
| Tapioca Flour | 8.7 | 8.6 | 9.5 | 8.2 |
| Melamine Urea | 34.8 | 44.7 | 41.6 | 39.0 |
| Formaldehyde | | | | |
| Ammonium Chloride | 0.7 | 0.9 | 0.8 | 0.8 |
| Soya Extract | 0.9 | 1.7 | 1.9 | 2.1 |
| Impact Modifier | 1.7 | 0.0 | 0.0 | 0.0 |

TABLE 1B
(all amounts in wt %)

| | Example 5 | Example 6 | Example 7 |
|---|---|---|---|
| Plant Fibre | 50.0 | 51.7 | 52.0 |
| Tapioca Flour | 8.6 | 8.9 | 9.3 |
| Melamine Urea Formaldehyde | 38.5 | 37.7 | 37.1 |
| Ammonium Chloride | 0.8 | 0.8 | 0.7 |
| Soya Extract | 2.1 | 0.9 | 0.9 |
| Impact Modifier | 0.0 | 0.0 | 0.0 |

TABLE 1C
(all amounts in wt %)

| | | Example 8 | Example 9 |
|---|---|---|---|
| Plant | Agricultural and/or Horticultural Waste | 47.8 | 47.4 |
| Fibre | Oil Palm Fibre | 2.1 | 4.6 |

| | | |
|---|---|---|
| Tapioca Flour | 8.2 | 9.3 |
| Melamine Urea Formaldehyde | 39.0 | 37.1 |
| Ammonium Chloride | 0.8 | 0.7 |
| Soya Extract | 2.1 | 0.9 |
| Impact Modifier | 0.0 | 0.0 |

Table 2 illustrates examples of mouldable compositions that may be used to form a tray in accordance with one embodiment of the present invention.

TABLE 2
(all amounts in wt %)

| | Example 10 |
|---|---|
| Plant Fibre | 64.1 |
| Tapioca Flour | 11.4 |
| Melamine Urea Formaldehyde | 22.9 |
| Ammonium Chloride | 0.5 |
| Soya Extract | 1.1 |
| Impact Modifier | 0.0 |

Table 3 illustrates examples of mouldable compositions that may be used to form a flowerpot in accordance with one embodiment of the present invention.

TABLE 3
(all amounts in wt %)

| | Example 11 | Example 12 |
|---|---|---|
| Plant Fibre | 68.0 | 70.2 |
| Tapioca Flour | 12.2 | 12.5 |
| Melamine Urea Formaldehyde | 18.2 | 15.7 |
| Ammonium Chloride | 0.4 | 0.3 |
| Soya Extract | 1.2 | 1.3 |
| Impact Modifier | 0.0 | 0.0 |

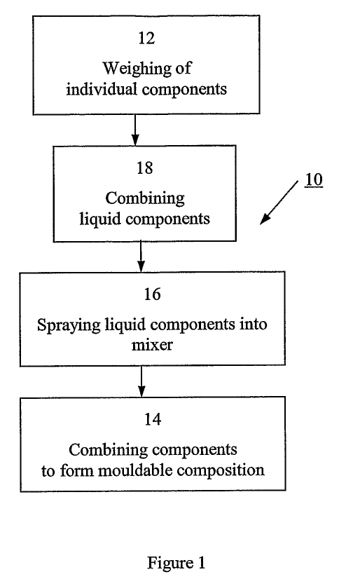

FIG. 1 is a flow chart illustrating a method 10 to prepare a mouldable composition in accordance with one embodiment of the present invention. The mouldable composition comprises about 40 to 60 percentage weight (wt %) of a fibre mixture, about 15 to 45 wt % of melamine urea formaldehyde, about 0.1 to 0.4 wt % of ammonium chloride, about 6 to 18 wt % of tapioca flour and about 0.2 to 0.9 wt % of soy lecithin.

Method 10 begins by weighing 12 each of the components of the mouldable composition individually using a gain-in-weight principle or under vacuum.

The components of the mouldable composition are sequentially combined 14 in a mixer for between about 300 to 600 seconds (s) to form a substantially homogeneous and well-coated mouldable composition.

The fibre mixture is first added to the mixer and blended for about 10 seconds (s) prior to the addition of tapioca flour. The tapioca flour and the fibre mixture are blended for about 20 s. After which, soy lecithin, followed by melamine urea formaldehyde, and then ammonium chloride is added to the mixer and blended for another period of about 300 s to achieve homogeneity in the mouldable composition.

The liquid components such as melamine urea formaldehyde and ammonium chloride may be fed into the mixer by a pneumatic actuator or a volumetric screw feeder.

In a preferred embodiment, the liquid components are sprayed 16 into the mixer to coat the fibres in the fibre mixture evenly. Spraying 16 of the liquid components into the mixer ensures an even distribution of the liquid components in the mouldable composition. An air operated diaphragm pump or a spraying nozzle may be used to spray 16 the liquid components into the mixer.

Where the mouldable composition includes more than one liquid component, the liquid components may be combined 18 in a second mixer for about 200 s to form a liquid mixture before spraying 16 into the mixer. The combination 18 of the liquid components may take place concurrently with the combination 12 of the components of the mouldable composition.

The use of a mixer with twin rotor shafts and overlapping paddles is preferred to reduce the mixing time required to achieve homogeneity of the mouldable composition and to create a fluidising zone in the mixer. The creation of a fluidising zone reduces friction during mixing and therefore minimises heat generation to prevent premature curing of the mouldable composition.

Although the mixer may be operated at a rotor speed of between about 10 to 200 revolutions per minute (rpm), it is preferable to operate the mixer at a rotor speed of about 29 rpm to minimise the shearing force acting on the mouldable composition and the heat generated. High shearing force will cause the fibres to disintegrate.

The mixer may be provided with side doors measuring at least about 600 mm in height by at least about 600 mm in width to allow an efficient discharge of the mouldable composition with minimal residue remaining. The provision of large side doors also allows for quick inspection, fast cleaning and good access.

The moisture content of the mouldable composition is preferably less than about 20%, more preferably between about 4 to 15%. A higher moisture content will cause the mouldable composition to have insufficient viscosity to distribute the shearing force from the mixer to coat the fibres uniformly.

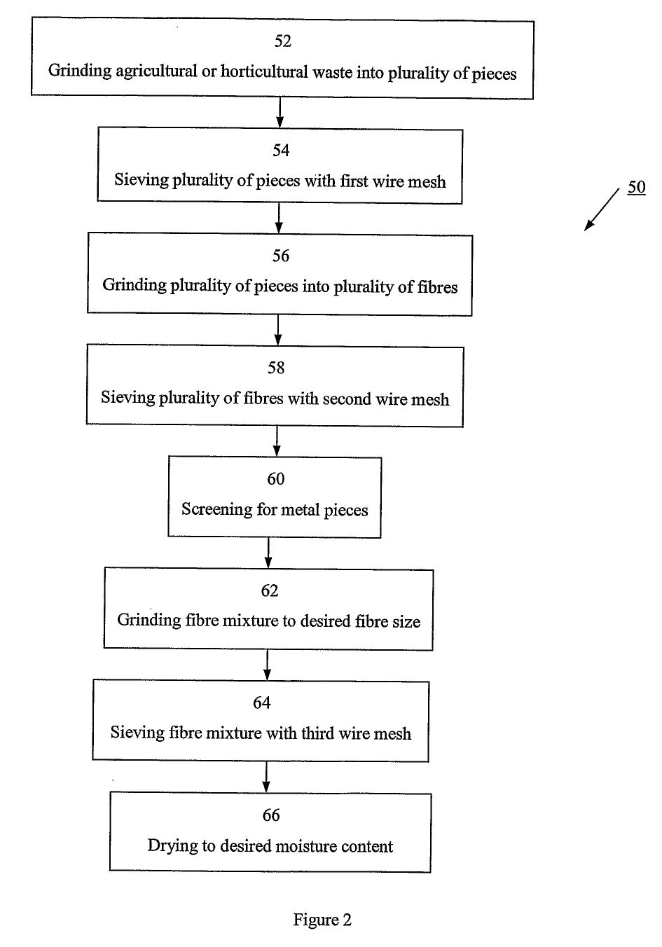

FIG. 2 is a flow chart illustrating a method 50 to prepare a fibre mixture in accordance with one embodiment of the present invention. Method 50 begins when a quantity of wood waste, agricultural or horticultural waste is received in a first grinder where it is ground 52 into a plurality of pieces of waste, each piece of waste measuring between about 10 to 80 mm in length and between about 2 to 20 mm in width.

The plurality of pieces of waste may be sieved 54 with a first wire mesh having a plurality of apertures measuring about 80 mm in diameter, prior to being conveyed to a second grinder for grinding 56 into a plurality of fibres. The plurality of fibres, each fibre measuring between about 5 to 50 mm in length and between about 2 to 10 mm in width, may then be sieved 58 with a second wire mesh having a plurality of apertures measuring about 50 mm in diameter.

The plurality of fibres is screened 60 for metal pieces using a metal detector. The metal pieces are removed from the plurality of fibres before it is fed together with a plurality of oil palm fibres into a third grinder. The resultant fibre mixture is then ground 62 into fibres having a length of up to about 50 mm and a thickness of up to about 2 mm. Following which, the fibre mixture may be sieved 64 with a third wire mesh having a plurality of apertures measuring about 20 mm in diameter.

Although a single grinder may be employed to prepare a fibre mixture with the desired fibre dimensions, three separate grinders are preferred to minimise material handling and cutter alignment, and also to prevent jamming of the grinder. As an alternative to sieving, foreign materials, oversized particles and big fibres may be removed manually.

The fibre mixture is then dried 66 to a moisture content of less than about 15%. The fibre mixture may be spread out on a cemented floor of a drying shelter to dry for between about 1 to 2 weeks. The fibre mixture may be dried using spotlights, a dry air blower, ultraviolet (UV) light from the sun or a rotary dryer with a heating system. Occasionally, the fibre mixture may be redistributed to achieve a uniform dryness. Random samples of the fibre mixture may be analysed to determine if the desired fibre size, moisture content and composition has been achieved prior to delivery or to storage in a silo.

The fibre mixture may be transported around a manufacturing plant with a screw conveyor. The fibre mixture may be conveyed from the screw conveyor to the storage silo using an aeromechanical conveyor.

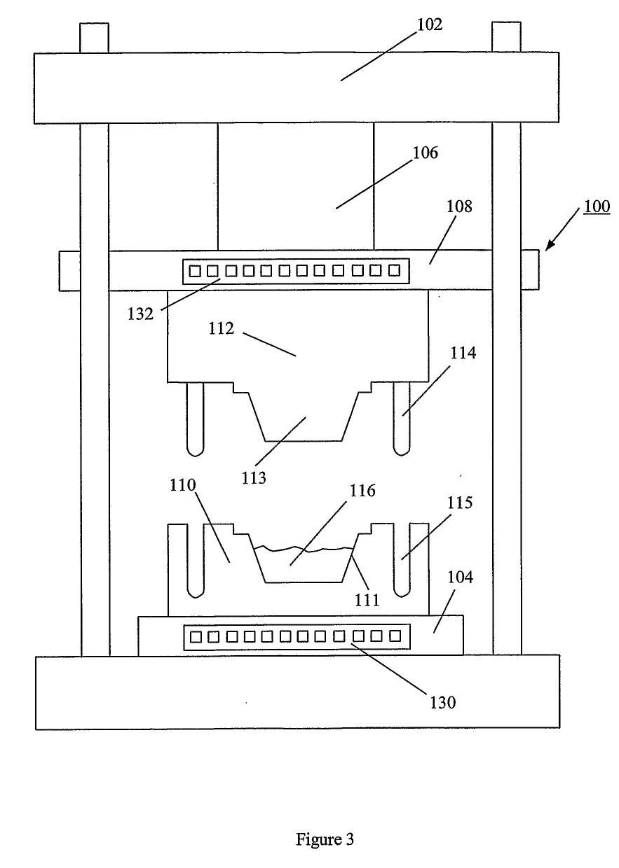

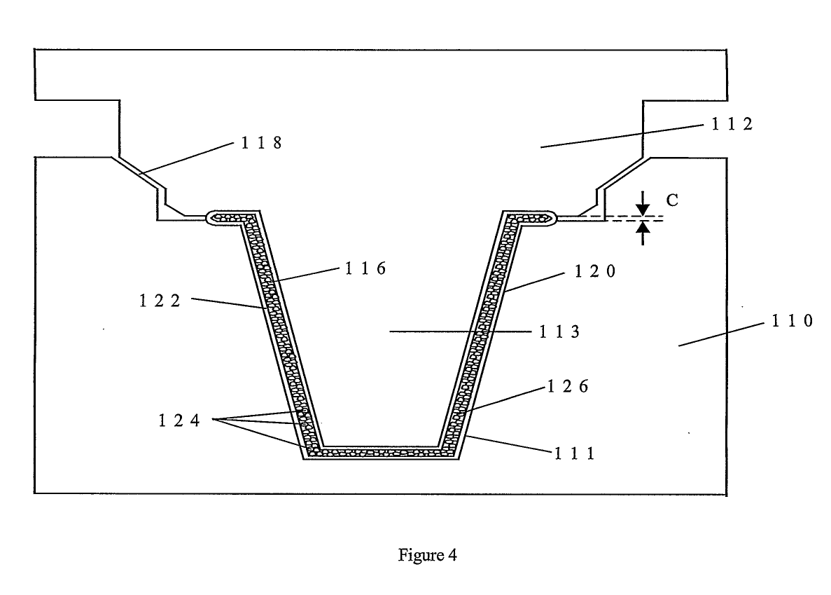

A press for manufacturing a moulded product from the mouldable composition is illustrated in FIGS. 3 and 4 in accordance with one embodiment of the present invention.

FIG. 3 illustrates a press 100 to form the moulded product in accordance with one embodiment of the present invention. Press 100 comprises a frame 102 having a first platen 104 and a plunger 106 coupled to a second platen 108. A first or female mould part 110 defining a mould cavity 111 is provided on first platen 104, while a second or male mould part 112 defining a mould plunger 113 is coupled to second platen 108. Plunger 106 is to move mould plunger 113 towards and away from mould cavity 111. Second mould part 112 may be provided with one or more guide pin(s) 114 that co-operate with complementary elongate recesses 115 in first mould part 110 to align mould plunger 113 with mould cavity 111 when plunger 106 is in operation.

Press 100 may be a mechanical press, a pneumatic press or a hydraulic press. The use of a hydraulic press is preferred as it offers greater control flexibility—the force applied, the direction, the speed, the duration of pressure dwell, et cetera, may be adjusted accordingly.

To form the moulded product, mould cavity 111 is first loaded with a mouldable composition 116, up to about 90% of the capacity of mould cavity 111. The degree to which mould cavity 111 is filled is dependent on the compression ratio of the moulded product, that is, the ratio of the wet weight to the dry weight of the moulded product. The wet weight of a moulded product is the weight of the mouldable composition used to form the moulded product, while the dry weight of a moulded product is the weight of the moulded product after curing. The compression ratio is preferably between about 4:1 to 14:1. A shrinkage factor of about 1% in a transverse direction and 1.5% in a longitudinal direction is preferred.

First mould part 110 and second mould part 112 are maintained at a temperature of between about 110 to 180° C. by a first thermal oil heating system 130 and a second thermal oil heating system 132, respectively. A thermal controller (not illustrated) is provided to regulate the temperature of first mould part 110 and second mould part 112. First mould part 110 is preferably maintained at a temperature that is about 20° C. higher than a temperature of second mould part 112 to compensate for heat loss when mouldable composition 116 is loaded into mould cavity 111 and to prevent first mould part 110 and second mould part 112 from jamming due to thermal expansion of first mould part 110 and second mould part 112.

Mould plunger 113 is moved towards mould cavity 111 at a speed of about 80 millimetres per second (mm/s) until just before mould plunger 113 contacts mouldable composition 116. The speed is then reduced to between about 0.5 to 3 mm/s to prevent the application of a sudden impact on mouldable composition 116, which is undesirable as it induces stresses in mould plunger 113 and mouldable composition 116. A limit switch (not illustrated) may be used to reduce the speed at which mould plunger 113 approaches mould cavity 111.

The period of time between loading mouldable composition 116 into mould cavity 111 and bringing mould plunger 113 into contact with mouldable composition 116 is preferably minimised to ensure that mouldable composition 116 is cured uniformly.

As mould plunger 113 is gradually contacted with mouldable composition 116, a packing pressure of between about 435 to 870 pressure per square inch (psi) is applied to mouldable composition 116 and maintained during the moulding process. Packing pressure is defined as press tonnage divided by the surface area of mould cavity 111 and the volume of mouldable composition 116 in mould cavity 111.

Movement of mould plunger 113 towards mould cavity 111 ceases when a predetermined clearance of between about 0.1 to 0.5 mm is left between first mould part 110 and second mould part 112. Second mould part 112 is held at this position for between about 20 to 60 s to allow mouldable composition 116 to cure substantially.

Heat from first mould part 110 and second mould part 112 causes moisture in mouldable composition 116 to vaporise, resulting in an expansion of mouldable composition 116. The pressure applied to and the expansion of mouldable composition 116 causes it to fill a space in mould cavity 111 between first mould part 110 and second mould part 112. Moisture in the form of water vapour is released through the predetermined clearance between first mould part 110 and second mould part 112.

As the temperature of mouldable composition 116 increases, the adhesive in mouldable composition 116 begins to cure, increasing the viscosity of mouldable composition 116.

FIG. 4 illustrates an enlarged view of first mould part 110 and second mould part 112 during the formation of the moulded product in accordance with one embodiment of the present invention. A predetermined clearance C of between about 0.1 to 0.5 mm is maintained between first mould part 110 and second mould part 112, forming a vent 118.

Because an exterior surface layer 120 of mouldable composition 116 receives heat directly from first mould part 110 and second mould part 112, exterior surface layer 120 is of a higher temperature than the rest of mouldable composition 116 and cures at a faster rate, forming a skin 122 around mouldable composition 116. Skin 122 acts as insulation, reducing heat transmission from first mould part 110 and second mould part 112 to mouldable composition 116.

As mouldable composition 116 expands, vent 118 becomes occluded, preventing the release of water vapour. Accordingly, the pressure in mouldable composition 116 increases as moisture in mouldable composition 116 vaporises but is unable to escape. The trapped water vapour forms a plurality of vapour pockets 124 in mouldable composition 116, precipitating the formation of a porous structure 126 within mouldable composition 116.

Heat loss through the escape of water vapour from mouldable composition 116 is also prevented, resulting in an increase in the temperature of mouldable composition 116. The size of the plurality of vapour pockets 124 increases with an increase in the temperature of mouldable composition 116.

When first mould part 110 and second mould part 112 are maintained at temperatures below 90° C., the quantity of moisture which vaporises is reduced and fewer vapour pockets are formed. Correspondingly, a moulded product with a higher density is produced. Conversely, higher temperatures of first mould part 110 and second mould part 112 will result in the formation of a moulded product with a lower density.

Higher temperatures of first mould part 110 and second mould part 112 also reduce the production time for a moulded product. However, temperatures greater than about 180° C. are undesirable as such high temperatures will burn the fibres in mouldable composition 116 and vaporise too much of the moisture in mouldable composition 116, resulting in the formation of a moulded product that is too dry.

Therefore, the temperatures of first mould part 110 and second mould part 112 are preferably maintained between about 110 to 180° C. Experiments have shown that when the temperatures of first mould part 110 and second mould part 112 are within such a range, the temperature of mouldable composition 116 is between about 100 to 160° C. By controlling the distribution of heat within mouldable composition 116, vaporisation of moisture from mouldable composition 116 may be controlled to ensure an even distribution of the plurality of vapour pockets 124 within porous structure 126 to form a moulded product with uniform density.

When the pressure in mouldable composition 116 exceeds the external pressure, the occlusion to vent 118 ruptures, allowing excess mouldable composition 116, water vapour from mouldable composition 116 and vapour from the curing of the adhesive to escape through vent 118, reducing the pressure in mouldable composition 116.

Clearance C is calculated to allow the release of water vapour during the moulding process, while maintaining sufficient pressure to fill the space in mould cavity 111 between first mould part 110 and second mould part 112. By regulating clearance C between first mould part 110 and second mould part 112, the size of vent 118, the pressure in and temperature of mouldable composition 116 and the volume of excess mouldable composition 116 discharged may be controlled.

For example, a larger clearance C allows more water vapour and mouldable composition to escape, resulting in a lower pressure build-up, reduced vapour expansion and the formation of a moulded product with a higher density. Conversely, a smaller clearance C restricts the release of water vapour, induces vapour expansion and produces a moulded product with a lower density.

However, too large a clearance C is undesirable as then mouldable composition 116 will not be able to occlude vent 118. Consequently, there will be no pressure build-up and the mouldable composition will not fill the space in mould cavity 111 between first mould part 110 and second mould part 112. When this happens, the moulded product formed will not be of a desired shape.

The size of clearance C is also dependent on the moisture content in mouldable composition 116. The use of a smaller clearance C is preferred when mouldable composition 116 contains less moisture; the use of a larger clearance C is preferred when mouldable composition contains more moisture as under such circumstances, more water vapour is emitted.

The moulded product is formed when mouldable composition 116 is substantially cured, preferably about 90% cured. The moisture content of the moulded product is preferably between about 2 to 5%. Plunger 106 is then activated to increase clearance C to about 10 mm to release all the unwanted vapours discharged in the course of the moulding process.

If clearance C is increased before mouldable composition 116 is substantially cured, the amount of moisture removed from mouldable composition 116 will be inadequate, and the moulded product will be soft and will tend to adhere to mould cavity 111 and mould plunger 113. Separation of mould plunger 113 from mould cavity 111 would then distort exterior surface layer 120 and damage porous structure 126. Therefore, the removal of moisture from mouldable composition 116 is vital to achieving a moulded product with sufficient strength to withstand stress and strain during processing and handling.

Subsequent to the release of unwanted vapours, clearance C may be reduced to between about 0.05 to 0.3 mm and held there for between about 15 to 60 s to compress the moulded product to a desired thickness and to iron the surface of the moulded product to give a good surface finish. Further vaporisation of moisture occurs, resulting in the formation of a stable moulded product.

Thereafter, plunger 106 is activated to draw mould plunger 113 away from mould cavity 111 and the moulded product is removed for subsequent processing. The moulded product may be removed from mould cavity 111 with a pick and place mechanism.

Mould cavity 111 is preferably provided with an ejection mechanism to lift the moulded product from mould cavity 111 when clearance C is increased to about 10 mm to release the unwanted vapours and also to assist in the removal of the moulded product from mould cavity 111.

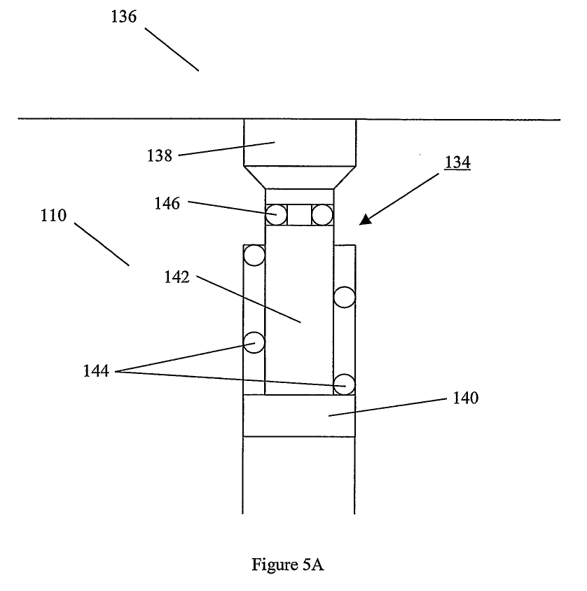

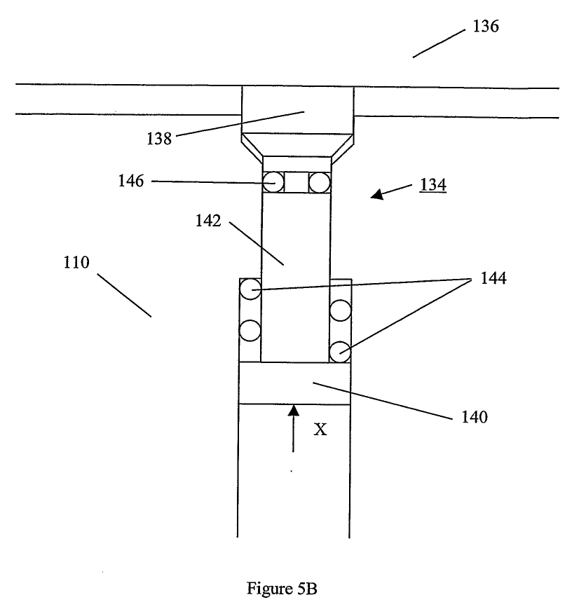

FIGS. 5A and 5B illustrate a cross-sectional view of an ejection mechanism 134 in accordance with embodiment of the present invention. FIG. 5A is an illustration of ejection mechanism 134 at rest, while FIG. 5B is an illustration of ejection mechanism 134 in operation.

Referring first to FIG. 5A, ejection mechanism 134 is housed in mould cavity 111 and positioned under a moulded product 136. Ejection mechanism 134 comprises a head 138 coupled to a base 140 by a shaft 142 and a spring 144 around shaft 142. At rest, spring 144 is in an uncompressed state.

In this embodiment, ejection mechanism 134 is operated by a pneumatic system (not illustrated). Shaft 142 may be provided with an O-ring 146 to prevent a loss of air from the pneumatic system. In an alternative embodiment, ejection mechanism 134 may be operated by a hydraulic system

When clearance C is increased or when moulded product 136 is to be removed from mould cavity 111, the pneumatic system is activated and exerts a force on base 140, driving ejection mechanism 134 in a direction X as illustrated in FIG. 5B and compressing spring 144 in the process. Accordingly, moulded product 136 is lifted from mould cavity 111.

Ejection mechanism 134 is returned to the position of rest illustrated in FIG. 5A by deactivating the pneumatic system. Correspondingly, spring 144 is released from its compressed state. The expansion of spring 144 exerts a force on base 140, driving ejection mechanism 134 in an opposite direction relative to direction X until the position of rest is attained.

The pneumatic or hydraulic system may be operated with the same limit switch that is used to reduce the speed at which mould plunger 113 approaches mould cavity Referring back to FIG. 4, mouldable composition 116 should not be left in mould cavity 111 for an extended period of time as then the adhesive and the fibre mixture may absorb too much heat and become burnt. Cracks and deformation may also occur if mouldable composition 116 is left in mould cavity 111 for an extended period of time as then too much moisture will be lost.

The degree to which mould cavity 111 is filled affects the density of the moulded product. If insufficient mouldable composition 116 is loaded into mould cavity 111, there will not be enough of mouldable composition 116 to fill the space in mould cavity 111 between first mould part 110 and second mould part 112 and there will be insufficient pressure build-up to form porous structure 126. As such, a dense moulded product with high moisture content is formed when insufficient mouldable composition 116 is loaded into mould cavity 111.

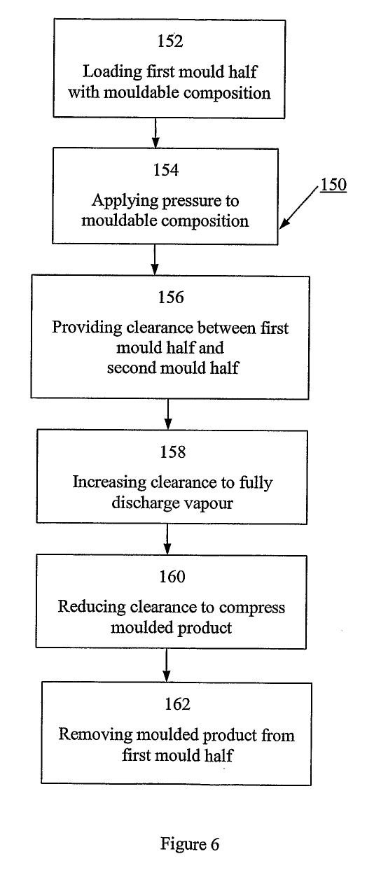

FIG. 6 is a flow chart illustrating a method 150 to form a moulded product in accordance with another embodiment of the present invention. Method 150 begins by loading 152 a mould cavity of a first mould part with a mouldable composition. The mould cavity may be loaded 152 up to about 90% of the capacity of the mould cavity.

A packing pressure of between about 435 to 870 psi is applied 154 to the mouldable composition for between about 20 to 60 s to allow the mouldable composition to cure. A predetermined clearance of between about 0.1 to 0.5 mm is maintained 156 between the first mould part and a second mould part to allow the discharge of excess mouldable composition, water vapour and other vapours released during the curing of the mouldable composition. The first mould part and the second mould part are maintained at a temperature of between about 110 to 180° C. The first mould part is preferably maintained at a temperature of about 20° C. higher than a temperature of the second mould part to compensate for heat loss when the mouldable composition is loaded into the mould cavity and to prevent the first mould part and the second mould part from jamming due to thermal expansion of the first mould part and the second mould part.

The clearance between the first mould part and the second mould part is increased 158 to about 10 mm when the mouldable composition is substantially cured, preferably about 90% cured, forming the moulded product. When the water vapour and other vapours released during the curing of the mouldable composition are substantially discharged, the clearance is reduced 160 to between about 0.05 to 0.3 mm for between about 15 to 60 s. This is done to compress the moulded product to a desired thickness and to iron the surface of the moulded product before removing 162 the moulded product from the mould cavity.

Tables 4A and 4B illustrate examples of process parameters that may be used to form a pallet in accordance with one embodiment of the present invention.

TABLE 4A

| | Example 1 | Example 2 | Example 3 |
|---|---|---|---|
| Percentage Volume of Mould Cavity | 70 | 80 | 90 |
| Filled (vol %) | | | |
| Temperature of Mould Cavity (° C.) | 125 | 125 | 125 |
| Temperature of Mould Plunger (° C.) | 105 | 105 | 105 |
| Packing Pressure (psi) | 870 | 870 | 870 |
| Curing Time (s) | 60 | 60 | 40 |
| Curing Clearance (mm) | 0.8 | 0.6 | 0.5 |
| Ironing Time (s) | 60 | 60 | 60 |
| Ironing Clearance (mm) | 0.5 | 0.3 | 0.1 |

TABLE 4B

| | Example 4 | Example 5 | Example 6 |
|---|---|---|---|
| Percentage Volume of Mould Cavity | 85 | 87 | 92 |
| Filled (vol %) | | | |
| Temperature of Mould Cavity (° C.) | 125 | 130 | 130 |
| Temperature of Mould Plunger (° C.) | 105 | 110 | 110 |
| Packing Pressure (psi) | 870 | 870 | 870 |
| Curing Time (s) | 50 | 60 | 60 |
| Curing Clearance (mm) | 0.4 | 0.2 | 0.5 |
| Ironing Time (s) | 60 | 40 | 60 |
| Ironing Clearance (mm) | 0.1 | 0.05 | 0.2 |

Tables 5A and 5B illustrate examples of process parameters that may be used to form a flowerpot in accordance with one embodiment of the present invention.

TABLE 5A

| | Example 7 | Example 8 | Example 9 |
|---|---|---|---|
| Percentage Volume of Mould Cavity | 85 | 87 | 91 |
| Filled (vol %) | | | |
| Temperature of Mould Cavity (° C.) | 100 | 100 | 125 |
| Temperature of Mould Plunger (° C.) | 80 | 80 | 105 |
| Packing Pressure (psi) | 435 | 580 | 725 |
| Curing Time (s) | 30 | 30 | 30 |
| Curing Clearance (mm) | 1.5 | 1.2 | 1.8 |
| Ironing Time (s) | 30 | 30 | 30 |
| Ironing Clearance (mm) | 1.0 | 1.0 | 1.0 |

TABLE 5B

| | Example | Example | Example |
|---|---|---|---|
| | 10 | 11 | 12 |
| Percentage Volume of Mould Cavity | 65 | 75 | 60 |
| Filled (vol %) | | | |
| Temperature of Mould Cavity (° C.) | 125 | 125 | 130 |
| Temperature of Mould Plunger (° C.) | 105 | 105 | 110 |
| Packing Pressure (psi) | 435 | 650 | 870 |
| Curing Time (s) | 30 | 60 | 60 |
| Curing Clearance (mm) | 1.2 | 1.0 | 2.0 |
| Ironing Time (s) | 30 | 60 | 15 |
| Ironing Clearance (mm) | 1.0 | 0.8 | 0.8 |

Apart from pallets, trays and flowerpots, it will be appreciated that the invention may be used to mould a variety of products such as, for example, partition boards, ammunition containers, speaker boards, electronic casing, cups, plates, car bumpers, steering wheels, panel boards, car seats, chair seats and table tops.

Other embodiments of the invention will be apparent to those skilled in the art from consideration of the specification and practice of the invention. The word “comprising” and forms of the word “comprising” as used in the description and in the claims are not meant to exclude variants or additions to the invention. Furthermore, certain terminology has been used for the purposes of descriptive clarity, and not to limit the present invention. The embodiments and preferred features described above should be considered exemplary, with the invention being defined by the appended claims.

1. A method to form a moulded product, the method comprising:
preparing a mouldable composition, the mouldable composition comprising:
between about 40 to 60 wt % of a fibre mixture; and
between about 15 to 45 wt % of an adhesive,
loading a mould cavity with the mouldable composition, wherein the mould cavity is loaded up to about 90% of the capacity of the mould cavity;
applying a packing pressure of between about 435 to 870 psi to the mouldable composition;
maintaining a predetermined clearance of between about 0.1 to 0.5 mm between a first mould part defining the mould cavity and a second mould part; and
removing the moulded product from the mould cavity when the mouldable composition is substantially cured.

2. The method to form a moulded product according to claim 1, wherein the pressure is applied for a period of between about 20 to 60 s.

3. The method to form a moulded product according to claim 2, wherein the first mould part and the second mould part are maintained at a temperature of between about 110 to 180° C.

4. The method to form a moulded product according to claim 3, wherein the first mould part is maintained at a temperature of about 20° C. higher than a temperature of the second mould part.

5. The method to form a moulded product according to claim 2, further comprising:
increasing the clearance between the first mould part and the second mould part when the mouldable composition is about 90% cured.

6. The method to form a moulded product according to claim 5, wherein the clearance is increased to about 10 mm.

7. The method to form a moulded product according to claim 6, further comprising:
compressing the moulded product to a desired thickness.

8. The method to form a moulded product according to claim 7, further comprising:
ironing a surface of the moulded product.

9. The method to form a moulded product according to claim 8, wherein compressing the moulded product to the desired thickness and ironing the surface of the moulded product further comprises:
reducing the clearance to between about 0.05 to 0.3 mm.

10. The method to form a moulded product according to claim 9, wherein the clearance is reduced for between about 15 to 60 s.

11. The method to form a moulded product according to claim 1, wherein a moisture content of the mouldable composition is less than about 20%.

12. The method to form a moulded product according to claim 11, wherein a moisture content of the mouldable composition is between about 4 to 15%.

13. The method to form a moulded product according to claim 11, wherein a moisture content of the fibre mixture is less than about 15%.

14. The method to form a moulded product according to claim 12, wherein the mouldable composition further comprises not more than about 40 wt % of an additive.

15. The method to form a moulded product according to claim 14, wherein the additive is one or more of a group consisting of a hardener, a flow promoter and a mould release agent.

16. The method to form a moulded product according to claim 1, wherein the fibre mixture comprises a plurality of fibres and wherein each of the plurality of fibres is of a length of up to about 50 mm.

17. The method to form a moulded product according to claim 16, wherein each of the plurality of fibres is of a thickness of up to about 2 mm.

18. The method to form a moulded product according to claim 17, wherein each of the plurality of fibres is of a length to a thickness ratio of between about 2:1 to 25:1.

19. The method to form a moulded product according to claim 1, wherein the fibre mixture further comprises between about 5 to 30 wt % of an oil palm fibre.

20. The method to form a moulded product according to claim 1, wherein fibre mixture further comprises one of a group consisting of oil palm fibres, beer malt, sugarcane pulp, a plasticizer, a toughening agent and an impact modifier.

21. The method to form a moulded product according to claim 1, wherein the adhesive is a thermosetting resin.

22. The method to form a moulded product according to claim 21, wherein the adhesive is an amino resin.

23. The method to form a moulded product according to claim 21, wherein the adhesive further comprises a melamine.

24. The method to form a moulded product according to claim 23, wherein the adhesive is one of a group consisting of melamine formaldehyde and melamine urea formaldehyde.

25. The method to form a moulded product according to claim 1, wherein preparing the mouldable composition comprises:
weighing each component of the mouldable composition individually; and
combining each component of the mouldable composition in a mixer to form a substantially homogeneous and well-coated mouldable composition.

26. The method to form a moulded product according to claim 25, wherein preparing the mouldable composition further comprises:
combining each liquid component of the mouldable composition in a second mixer to form a liquid mixture.

27. The method to form a moulded product according to claim 26, wherein preparing the mouldable composition further comprises:
spraying the liquid mixture into the mixer.

28. The method to form a moulded product according to claim 27, wherein the mixer is operated at a rotor speed of about 29 rpm.

29. A method to form a moulded product, the method comprising:
loading a cavity of a mould with a mouldable composition comprising between about 40 to 60 wt % of a fibre mixture and between about 15 to 45 wt % of an adhesive, wherein the cavity is loaded up to about 90% of the capacity of the cavity;
activating the mould so as to apply a packing pressure in the range 435 to 870 psi to the mouldable composition therein;
providing a moisture vapour vent responsive to pressure in the mouldable composition and set to provide a predetermined control of moisture vapour content and thereby pressure in the composition, whereby to produce a moulded product having predetermined density and strength; and
removing the moulded product from the mould cavity when the mouldable composition is substantially cured.

30. The method according to claim 29 wherein the vent is provided by maintaining a clearance between respective parts of the mould adjacent the mouldable composition.

31. The method according to claim 29 wherein the vent is temporarily occluded by the mouldable composition in the mould to temporarily prevent release of moisture vapour for a predetermined period.

32. The method according to claim 29 wherein the moisture vapour content is controlled to generate bubbles of the vapour in the mouldable composition and thereby produce a porous moulded product of predetermined density.
